(19) United States
(12) Patent Application Publication
(10) Pub. No.: US 2026/0284789 A1
(43) Pub. Date: Sep. 24, 2026

(54) LASER IRRADIATION METHOD, LASER IRRADIATION DEVICE, LASER MARKING DEVICE, AND FABRICATING APPARATUS

(71) Applicants: Takuei NISHIO, Kanagawa (JP); Muneaki IWATA, Kanagawa (JP); Keiichi SERIZAWA, Kanagawa (JP)

(72) Inventors: Takuei NISHIO, Kanagawa (JP); Muneaki IWATA, Kanagawa (JP); Keiichi SERIZAWA, Kanagawa (JP)

(21) Appl. No.: 19/490,959

(22) PCT Filed: Jun. 26, 2024
(86) PCT No.: PCT/IB2024/056183

§ 371 Date: Dec. 8, 2025

(30) Foreign Application Priority Data
Jul. 3, 2023 (JP) 2023-109330

(51) Int. Cl. B23K 26/342; B22F 10/28; B22F 12/41; B23K 26/082; B29C 64/153; B29C 64/268; B33Y 30/00; G02B 26/10

(52) U.S. Cl. CPC B23K 26/342; B22F 10/28; B22F 12/41; B23K 26/082; B29C 64/153; B29C 64/268; B33Y 30/00; G02B 26/101

(57) ABSTRACT

A laser irradiation method includes causing a first deflector to deflect a laser beam, causing a second deflector to raster-scan an object with the laser beam deflected by the first deflector, the object having an irradiation region and a non-irradiation region separated from the irradiation region, and causing the first deflector to deflect the laser beam, which is moved to the non-irradiation region by the second deflector, to the irradiation region to irradiate the irradiation region with the laser beam.

### TECHNICAL FIELD

Embodiments of the present disclosure relate to a laser irradiation method, a laser irradiation device, a laser marking device, and a fabricating apparatus that deflect a laser beam to scan an object with the laser beam using multiple deflectors.

### BACKGROUND ART

A laser marking method in which a marking object is marked by scanning the marking object with a laser beam such as raster scan or vector scan is disclosed in PTL 1. The raster scan can increase the scanning speed (marking speed). However, since the raster scan scans a non-marking pixel with the laser beam turned off, there is room for effectively using the laser output or increasing the productivity.

### CITATION LIST

### Patent Literature

[PTL 1]
Japanese Patent No. 4108294

### SUMMARY OF INVENTION

### Technical Problem

An object of the present disclosure is to use the laser output effectively and increase the productivity in the raster scan of the laser beam.

### Solution to Problem

According to an embodiment of the present disclosure, a laser irradiation method includes causing a first deflector to deflect a laser beam, causing a second deflector to raster-scan an object with the laser beam deflected by the first deflector, the object having an irradiation region and a non-irradiation region separated from the irradiation region, and causing the first deflector to deflect the laser beam, which is moved to the non-irradiation region by the second deflector, to the irradiation region to irradiate the irradiation region with the laser beam. According to an embodiment of the present disclosure, a laser marking method includes causing a first deflector to deflect the laser beam in a first direction, causing a second deflector to raster-scan an object with the laser beam deflected by the first deflector at a scanning speed, the object having an irradiation region and a non-irradiation region separated from the irradiation region, and causing the first deflector to deflect the laser beam, which is moved to the non-irradiation region by the second deflector, to the irradiation region to irradiate the irradiation region with the laser beam when the second deflector accelerates or decelerates the scanning speed.

According to an embodiment of the present disclosure, a laser irradiation device includes a first deflector to deflect a laser beam, and a second deflector to raster-scan an object, having an irradiation region and a non-irradiation region separated from the non-irradiation region, with the laser beam deflected by the first deflector. The first deflector deflects the laser beam, which is moved to the non-irradiation region by the second deflector, to the irradiation region to irradiate the irradiation region with the laser beam.

According to an embodiment of the present disclosure, a laser marking device includes a first deflector to deflect a laser beam, and a second deflector to raster-scan an object having an irradiation region and a non-irradiation region separated from the irradiation region at a scanning speed. The first deflector deflects the laser beam, which is moved to the irradiation region or the non-irradiation region by the second deflector, to the irradiation region to irradiate the irradiation region with the laser beam when the second deflector accelerates or decelerates the scanning speed.

According to an embodiment of the present disclosure, a fabricating apparatus includes the laser irradiation device to irradiate a powder layer with a laser beam to fabricate a fabricated layer, and a control unit to control the laser irradiation device to repeatedly fabricate the fabricated layer to fabricate a three-dimensional article.

### Advantageous Effects of Invention

According to embodiments of the present disclosure, the laser output can be effectively used and the productivity can be increased in the raster scan of the laser beam.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic plan view of a laser marking device according to an embodiment of the present disclosure.

FIG. 2 is a flowchart of marking with a laser beam.

FIG. 3 is a diagram illustrating a raster scan track by a galvano scanner and a deflection direction of an acousto-optic deflector.

FIG. 4A is a diagram illustrating an image pattern to be marked.

FIG. 4B is a diagram illustrating a typical marking method to mark the image pattern of FIG. 4A.

FIG. 4C is a diagram illustrating a marking method to mark the image pattern of FIG. 4A, according to an embodiment of the present disclosure.

FIG. 4D is a diagram illustrating a marking method to mark the image pattern of FIG. 4A, according to an embodiment of the present disclosure.

FIG. 5A is a diagram illustrating another image pattern to be marked.

FIG. 5B is a diagram illustrating a marking method to mark the image pattern of FIG. 5A, according to an embodiment of the present disclosure.

FIG. 5C is a diagram illustrating a marking method to mark the image pattern of FIG. 5A, according to an embodiment of the present disclosure.

FIG. 6A is a schematic plan view of a laser marking device according to another embodiment of the present disclosure.

FIG. 6B is a schematic side view of the laser marking device in FIG. 6A.

FIG. 7A is a diagram illustrating still another image pattern to be marked.

FIG. 7B is a diagram illustrating a marking method to mark the image pattern of FIG. 7A, according to an embodiment of the present disclosure.

FIG. 8 is a flowchart of the marking in FIG. 7B.

FIG. 9 is a diagram illustrating a marking method to mark the image pattern of FIG. 7A using two acousto-optic deflectors, according to an embodiment of the present disclosure.

FIG. 10 is a diagram illustrating a marking method to mark the image pattern of FIG. 7A by extending a raster scan range in a y-direction, according to an embodiment of the present disclosure.

FIG. 11 is a diagram illustrating a deflection angle θ by an acousto-optic deflector.

FIG. 12A is a diagram illustrating an image pattern to be marked and irradiation density of a laser beam.

FIG. 12B is a diagram illustrating a scan track of the laser beam added to the diagram of FIG. 12A.

FIG. 13A is a diagram illustrating deflection of a laser beam by changing a deflection angle θ of an acousto-optic deflector.

FIG. 13B is a diagram illustrating deflection of a laser beam by changing a deflection angle θ of an acousto-optic deflector.

FIG. 13C is a diagram illustrating deflection of a laser beam by changing a deflection angle θ of an acousto-optic deflector.

FIG. 13D is a diagram illustrating deflection of a laser beam by changing a deflection angle θ of an acousto-optic deflector.

FIG. 14 is a diagram illustrating a marking method to allow a positional deviation of a marking.

FIG. 15A is a diagram illustrating an image pattern to be marked with a high speed marking.

FIG. 15B is a diagram illustrating a marking method to mark the image pattern of FIG. 15A with the high speed marking.

FIG. 16 is a diagram illustrating multiple laser beam irradiation at a time of acceleration or deceleration of a main scanning speed.

FIG. 17 is a diagram illustrating a marking method to mark two pixels when a laser beam passes one pixel.

FIG. 18 is a diagram illustrating a beam diameter of an acoustic wave propagating in an acousto-optic deflector.

FIG. 19 is a block diagram illustrating a laser irradiation control unit and a laser scanning control unit.

FIG. 20A is a diagram illustrating a control method of an acousto-optic deflector.

FIG. 20B is a timing chart of the control method of the acousto-optic deflector of FIG. 20A.

FIG. 21 is a diagram illustrating a powder bed fusion apparatus.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### Laser Marking Device

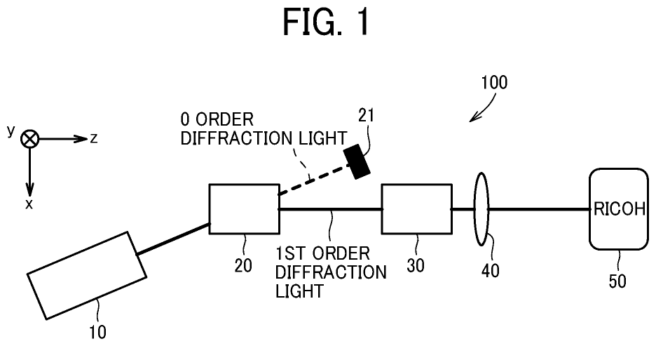

Embodiments of the present disclosure will be described below with reference to the drawings. FIG. 1 is a plan view of a laser marking device 100 according to an embodiment of the present disclosure. The laser marking device 100 includes a laser oscillator 10 as a laser light source, an acousto-optic deflector (AOD) 20 as a first deflector or a first scanning device, a galvano scanner 30 as a second deflector or a second scanning device, and an fθ lens 40. The acousto-optic deflector is referred to as an “AOD” below.

The AOD 20 includes a piezoelectric transducer connected to the crystal and a radio frequency (RF) driver that drives the piezoelectric transducer. The RF driver drives the piezoelectric transducer, and the AOD 20 generates an acoustic wave at an RF frequency in the crystal, for example, in a frequency range between about 50 megaheltz (MHz) and about 1500 MHz.

An incident laser beam is diffracted by the acoustic wave generated in the crystal in proportion to the RF frequency. A portion of the power of the incident laser beam is deflected as the first order diffraction light beam (diffraction light).

The laser beam emitted from the light source (laser oscillator 10) is deflected by the AOD 20, and the first order diffraction light beam (diffraction light) of the deflection light goes in the galvano scanner 30. The galvano scanner 30 raster-scans the fθ lens 40 with the laser beam that has gone in the galvano scanner 30 to generate a raster-scanned laser beam.

The raster-scanned laser beam goes in the fθ lens 40 that is a condenser lens. The marking object 50 is irradiated with the laser beam emitted from the fθ lens 40 to form a mark on the surface (or inside) of the marking object 50. The marking object 50 is a resin object such as a polyethylene terephthalate (PET) bottle.

The fθ lens 40 is configured to focus the laser beam with which the galvano scanner 30 has scanned the fθ lens 40 on the marking object 50. For example, the fθ lens 40 is configured to scan a marking object 50 on an imaging surface at a predetermined pitch with the laser beam with which the galvano scanner 30 scans the fθ lens 40 at each predetermined angle.

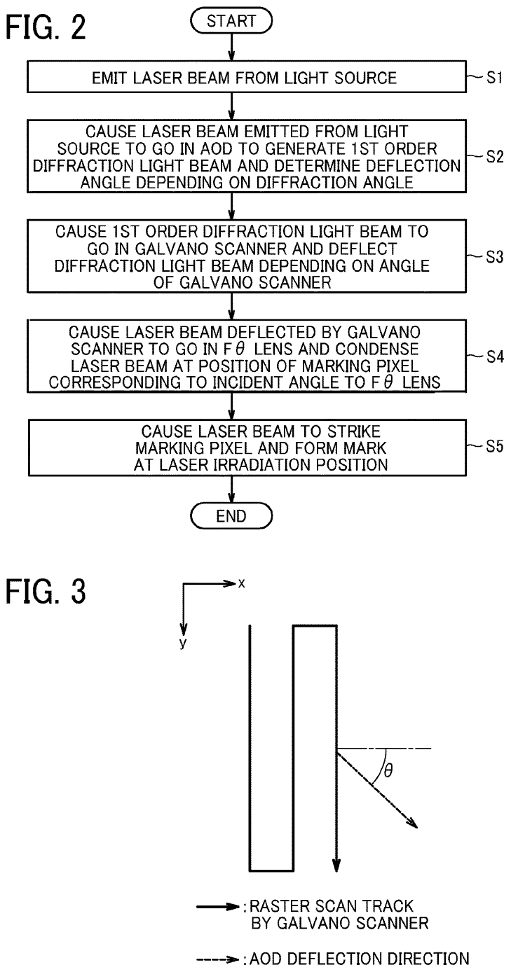

FIG. 2 is a flowchart from the light beam (laser beam) emission emitted from the light source (laser oscillator 10) to the marking of the marking object 50. The light beam emitted from the light source goes in the marking object 50, and the laser irradiation position is marked by the light beam. The light beam emitted from the light source (step S1) goes in the AOD 20 (step S2) as an incident light beam, and a portion of the incident light beam is diffracted at an angle corresponding to the wavelength of the incident light beam, the sound velocity of the AOD 20 crystal, and the frequency of the RF signal applied from the RF driver connected to the AOD 20, as the first order diffraction light beam (diffraction light). In the incident light beam to the AOD 20, another portion of the incident light beam that has not diffracted propagates straight as zero order light beam (i.e., transmitted light beam) as illustrated in FIG. 1, and is shielded (terminated) by the beam damper 21. In FIG. 1, the zero order light beam is shielded by the beam damper 21. When the power of the zero order light beam is so low that the marking object 50 is not marked even if the zero order light beam strikes the marking object 50, the zero order light beam may not be shielded.

The 1st order diffraction light beam goes in the galvano scanner 30, and the galvano scanner 30 deflects the 1st order diffraction light beam (deflected light beam) (step S3). The deflected light beam deflected by the galvano scanner 30 goes in the fθ lens 40 at an incident angle. The fθ lens 40 focuses the deflected light beam on a marking position of the marking object 50 corresponding to the incident angle (step S4).

The surface of the marking portion on the marking object 50 irradiated with the laser beam is scraped or denatured by the laser beam. As a result, a mark visually recognizable is formed (step S5).

The galvano scanner 30 scans the fθ lens 40 with the diffracted light beam (first order diffraction light beam) diffracted by the AOD 20. In other words, the AOD 20 and the galvano scanner 30 control the laser irradiation position on the marking object 50. Further, a beam diameter converter, a beam profile former, or a wave plate may be disposed before or after the AOD 20 of the laser marking device 100 illustrated in FIG. 1.

As a light source of the laser oscillator 10, for example, a pulse oscillation laser having a wavelength of 355 nanometers (nm), 532 nm, or 1064 nm can be used. The pulse oscillation laser is a type of laser in which the laser output varies with time. The pulse width is, for example, several tens of femtoseconds (fs) to several hundreds of nanoseconds (ns).

As a light source of the laser oscillator 10, a continuous wave (CW) oscillation laser may be used by switching instead of the pulse oscillation laser. The CW oscillation laser is a type of laser that outputs a constant value of the laser output without changing with time.

The RF driver drives the AOD 20, and the first order diffraction light beam propagates at an angle proportional to the RF frequency. Thus, the deflection angle of the AOD 20 can be controlled by controlling the RF frequency.

The deflection control by the AOD 20 does not have inertia unlike the galvano scanner 30 and the polygon scanner. Accordingly, the deflection control by the AOD 20 can deflect the laser beam at high speed (e.g., in a time of 5 microsecond (μs) or less).

In addition, the deflection control by the AOD 20 can give a deflection angle different for each pulse even to a pulse laser having a high repetition frequency (e.g., 200 kilohertz (kHz)). According to an embodiment of the present disclosure, the AOD 20 is used as the deflector, but the deflector is not limited to the AOD 20. The deflector may be any deflector having any response speed. As an alternative deflector to the AOD 20 is, for example, an electro-optical deflector (EOD), or a mirror optical deflector using a piezoelectric element that can response with high speed may be used.

As illustrated in FIG. 3, the angle formed between the deflection direction of the AOD 20 (represented by a dashed line) and the sub-scanning direction (+x-direction) of the galvano scanner 30 is defined as a deflection angle θ. The clockwise direction from +x to +y is defined as positive.

### Marking of 4×5 Pixel Image

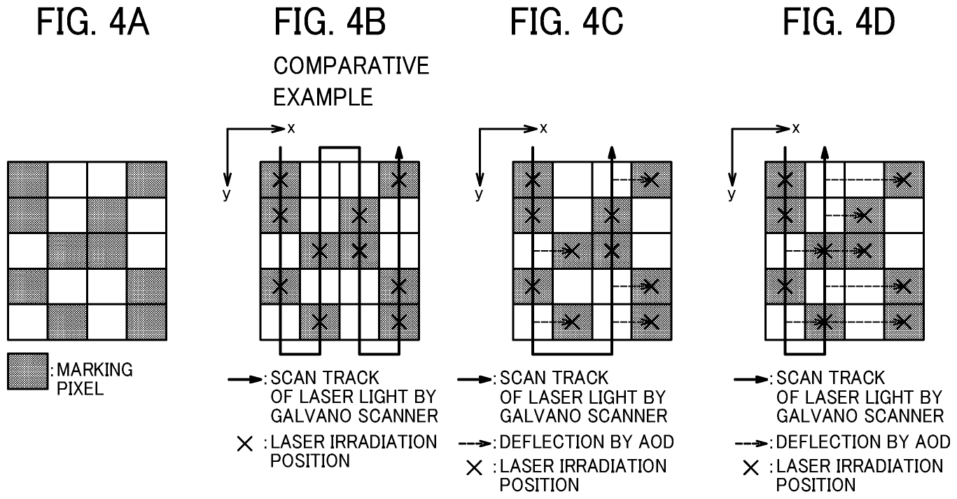

A specific marking method and an embodiment in which the time required for marking is shortened will be described with reference to the simple image pattern illustrated in FIGS. 4A to 4D. The marking is assumed to be performed on a 4×5 pixel image as illustrated in FIG. 4A. Although the image size is small, such as 4×5 pixels, for simplicity, the actual image size may be, for example, several hundred pixels x several hundred pixels or larger.

For convenience, the x-coordinate of the m-th column from the left is represented by m, the y-coordinate of the n-th row from the top is represented by n, and the coordinate of (x, y)=(m, n) is simply represented by (m, n). The pixels filled with gray are marking pixels (irradiation regions). The pixels filled with white are non-marking pixels (non-irradiation regions).

### Typical Marking

FIG. 4B is a diagram illustrating the relation between the scan track of the laser beam and the laser irradiation position in a typical raster scan as a comparative example. The main scanning direction of the galvano scanner 30 is represented by y, and the sub-scanning direction is represented by x, and the sub-scanning direction is directed from −x to +x.

The main scan indicates scanning in the column direction (+y-direction), and the sub-scan indicates movement to the next column. In a typical raster scan, all the main scanning columns including at least a single marking pixel are scanned. Thus, as illustrated in FIG. 4B, the marking of the marking pixel is completed by four main scans.

For simplicity, the laser light source is a pulsed laser unless otherwise specified in the following description. One pixel is marked by one pulse irradiation.

The laser irradiation pitch (pitch [meter (m)]=galvano main scanning speed [m/second(s)]/repetition frequency [1/s]) calculated from the galvano main scanning speed and the laser repetition frequency is assumed to coincide with the pixel size. However, when multiple pulse irradiations are required for marking one pixel, when the light source is not a pulse laser, or even when the laser irradiation pitch and the pixel size do not coincide with each other, an embodiment of the present disclosure has the same effect. Marking in Present Embodiment

FIG. 4C is a diagram illustrating a marking method according to an embodiment of the present disclosure. In FIG. 4C, the “scan track of the laser beam by the galvano scanner” represents a scan track of the laser beam generated by raster scan of the galvano scanner 30 when the deflection angle of the AOD 20 is maintained at a certain reference value.

The direction of deflection of the laser beam by the AOD 20 is θ=0 (+x-direction). The x- and y-coordinates of the scan track of the laser beam by the galvano scanner 30 at a certain time are represented by x0 and y0, respectively.

The amounts of deviation of the x- and y-coordinates of the laser beam due to the deflection angle control of the AOD 20 are represented by Δx and Δy (in pixel unit) as relative values from x0 and y0, respectively. For example, when x0=2 and Δx=1, the x-coordinate of the irradiation position of the laser beam is 3. The maximum value and the minimum value of Δx are represented by Δx_max and Δx_min, respectively, and the maximum value and the minimum value of Δy are represented by Δy_max and Δy_min, respectively.

The scan range of the AOD 20 on the marking object 50 (on the marking surface) is determined by the scan angle of view of the AOD 20 and the f lens 40. The ranges of Δx and Δy are determined from the relation between the scan range of the AOD 20 and the pixel size.

For example, in an embodiment of the present disclosure, the focal length of the fθ lens is 200 millimeters (mm), the scan angle of view (range of deflection angle to be modulated) of the AOD 20 is 2 milliradian (mrad), and the pixel size is 200 μm×200 μm. In this case, the scan range is 200 mm×2 mrad=400 μm.

Since θ=0, Δx_max−Δx_min and Δy_max−Δy_min are Δx_max−Δx_min=400 μm×cos(θ)/200 μm=2 and Δy_max−Δy_min=400 μm× sin(θ)/200 μm=0, respectively. Further, Δy/Δx=tan (θ).

The scan track of the laser beam by the galvano scanner 30 is the scan track when Δx is minimized (i.e., Δx_min=0), and the pixel size is 200 μm×200 μm. In this case, Δx can take a range of 0≤Δx≤2.

In the first column of the main scanning, the column of x=1 is scanned with the laser beam as in FIG. 4B. The (1, 3) pixel is not the marking pixel (non-marking pixels), and the (2, 3) pixel is the marking pixel that has not been marked yet (unmarking pixel). Thus, when the scan track of the laser beam is (x0, y0)=(1, 3), the deflection angle of the AOD 20 is controlled as Δx=1, and the laser beam, which is turned off in the typical method, is turned on to irradiate the position of the pixel (2, 3) (yet-to-be irradiated region) with the laser beam.

At (x0, y0)=(1, 4), since the (1, 4) pixel is a marking pixel, the (1, 4) pixel is irradiated with the laser beam as Δx=0 by controlling the deflection angle of the AOD 20. Similarly, at (x0, y0)=(1, 5), the deflection angle of the AOD 20 is controlled as Δx=1, and the laser beam, which is typically turned off, is turned on to irradiate the (2, 5) pixel (yet-to-be irradiated region) with the laser beam.

Thus, the first main scan is completed, and the marking for two rows of x=1 and 2 is completed. Further, for example, a row of x0=3 is selected as the second main scan row, and Δx is set as Δx=1, 1, 0, 0, and 1 for the positions of the scan track by the galvano scanner of (x0, y0)=(3, 5), (3, 4), (3, 3), (3, 2), and (3, 1), respectively.

In such a way, the marking of the marking image illustrated in FIG. 4A can be completed by two main scans, instead of four main scans in the typical method. The reason why the number of main scans can be reduced (i.e., high-speed marking) is that the laser irradiation position can be modulated for each pixel by a high-speed deflection scanning device such as the AOD 20, and marking can be performed during a time when the laser beam is turned off and marking is not performed in the typical raster scan.

In other words, since the galvano scanner 30 is combined with the AOD 20, the marking can be performed by the instantaneous deflective scan by the AOD 20 even at a timing when marking cannot be performed in the marking by the typical raster scan only by the galvano scanner 30. The present embodiment is particularly effective when a relatively sparse image pattern such as a character (having a large margin for use of laser output) is drawn in a short time by high-speed marking using raster scan.

In FIG. 4C, the row of x0=3 in the second main scan is set. In addition, for example, as illustrated in FIG. 4D, the row of x0=2 can be set in the scan. In other words, Δx is set as Δx=2, 2, 1, 1, and 2 for the scan track positions of the galvano scanner 30 of (x0, y0)=(2, 5), (2, 4), (2, 3), (2, 2), and (2, 1), respectively. The same effect can be obtained by scanning as illustrated in FIG. 4D.

As illustrated in FIG. 4D, the deflection angle of the laser beam by the AOD 20 as the first deflector is changed at the p-th raster scan and the (p+q)-th raster scan, where p and q are any integers, at predetermined coordinates in the raster scanning direction between the p-th raster scan and the (p+q)-th raster scan. In other words, in FIG. 4D, for example, Δx=1 when (x0, y0)=(1, 5), and Δx=2 when (x0, y0)=(2, 5).

There are various marking methods that can achieve the same effect (high-speed marking). However, depending on the condition of the fθ lens 40, when there is a restriction of Δx≤1, the marking cannot be performed as in FIG. 4D. Thus, the marking method illustrated in FIG. 4C is preferable.

### Marking of 5×6 Pixel Image

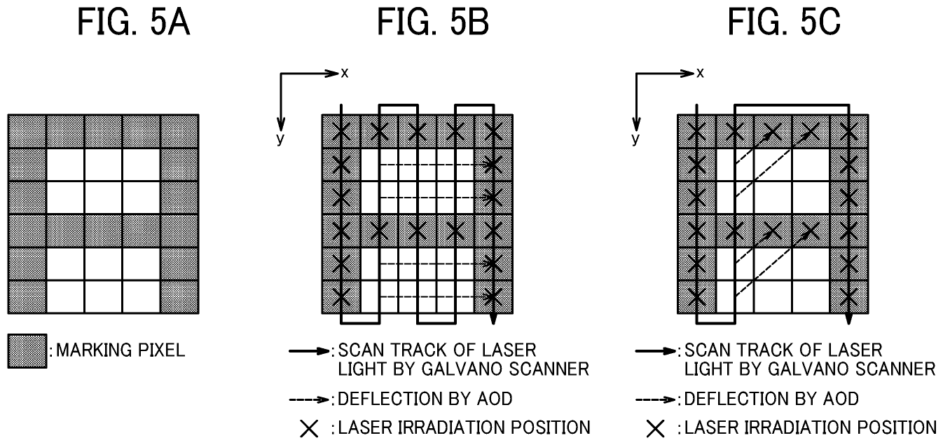

An efficient marking method for marking a 5×6 pixel image as illustrated in FIG. 5A will be described. In FIG. 5B, an example of marking in which the deflection direction of the AOD 20 is the +x-direction is illustrated, and in FIG. 5C, an example of marking in which the deflection direction of the AOD 20 is θ=−45° (the upper right direction in the drawing) is illustrated. As in the definition of Δx, the amount of deviation of the y-coordinate of the laser beam by the deflection angle control of the AOD 20 is Δy (in pixel unit) as a relative value from y0.

When the focal length of the fθ lens is 300 mm, the scan angle of view by AOD 20 is 2 mrad, and the pixel size is 200 μm×200 μm, the scan range of the AOD 20 is 600 μm. Thus, 0≤Δx≤3 in FIG. 5B, and 0≤Δx, and Δy≤2.1 in FIG. 5C, where Δy=−Δx.

In FIG. 5B, an example of marking in the case where the deflection direction of the AOD 20 is the +x-direction will be described. In this case, since the deflection direction of the AOD 20 is the same as the direction of the transverse line at y=1 and 4 rows of the marking pattern, as can be understood from FIG. 5B, the marking cannot be performed in the right columns in advance. Thus, five main scans are required to complete the marking, and the effect of high-speed marking cannot be obtained.

In FIG. 5C, an example of marking in the case where θ=−45° (in the upper right direction in the drawing) will be described. In this case, as illustrated in FIG. 5C, the deviations of (Δx, Δy)=(2, −2), (1, −1), (0, 0), (2, −2), (1, −1), and (0, 0) are set with respect to the scan track positions of the galvano scanner 30 of (x0, y0)=(2, 6), (2, 5), (2, 4), (2, 3), (2, 2), and (2, 1), respectively, in the second row of the main scan (x0=2), and the three rows of x=2, 3, and 4 can be marked by a single main scan.

As a result, the marking pattern of 5×6 pixel image illustrated in FIG. 5A can be marked by three main scans. As can be understood from this example, the effect of high-speed marking can be easily obtained by shifting the direction of a series of marking pixels that are located in the marking pattern and are continuous in one direction from the direction of deflection of the AOD 20. As an example of the procedure for determining θ, there is a method of calculating the number of main scan required to complete marking for each of multiple different θs (e.g., θ=0°, −45°, and) 45° and determining an angle at which the number of main scan is minimized.

In the example described above, when the sub-scanning direction is directed from −x to +x, the marking can be efficiently performed by selecting a column in which a pixel having the smallest x-coordinate (this x-coordinate is defined as x1) among the unmarked pixels can be marked as the main scan column of the galvano scanner 30. In other words, it is preferable to select x0 so that x0+Δx_min≤x1, where Δx_min is the minimum value that Δx can take. Since the marking time can be shorten by marking the column located as far as possible (i.e., close to Δx_max) in advance, x0+Δx_min=x1 may be applied.

### Marking Using Two AODs

The marking method using a single AOD has been described above. However, in an embodiment of the present disclosure, a marking method can use multiple AODs.

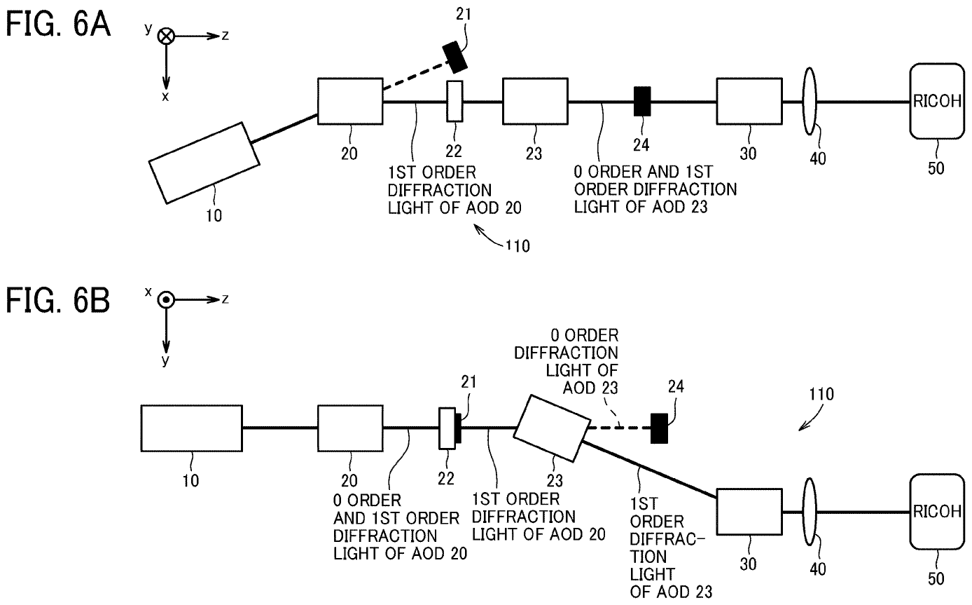

In other words, as illustrated in FIGS. 6A and 6B, the marking can be performed at high-speed by using two AODs 20 and 23 that can scan the marking object with the laser beam in two directions. FIG. 6A is a plan view of a laser marking device 110 using two AODs, and FIG. 6B is a side view of the laser marking device 110.

The polarization of the first order diffraction light beam by the AOD 20 as the first deflector is aligned with the polarization axis of the AOD 23 as the third deflector using the half wave plate, and the first order diffraction light beam is diffracted in a direction (+y-direction in FIG. 6B) perpendicular to the diffraction direction of the AOD 20 by the AOD 23. The first order diffraction light beam (diffraction light) by the AOD 23 goes in the galvano scanner 30 and is focused on the marking object 50 by the fθ lens 40. Since this configuration uses two AODs (i.e., the AOD 20 and the AOD 23), the laser irradiation position on the marking object 50 can be controlled in a two-dimensional manner.

### Marking of 13×8 Pixel Image

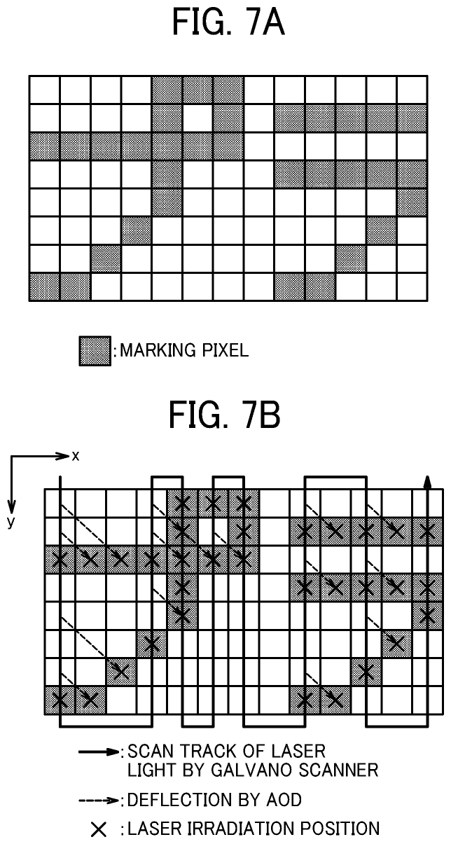

An example of marking of the 13×8 pixel image pattern illustrated in FIG. 7A will be described. FIG. 7B is a diagram illustrating an example of marking when a single AOD 20 is used. Since a single AOD 20 is used, the laser power available for marking can be increased as compared with the case where two AODs are used.

As illustrated in FIG. 7B, the deflection angle of the laser beam by the AOD 20 as the first deflector is changed at the p-th raster scan and the (p+q)-th raster scan, where p and q are any integers, at predetermined coordinates in the raster scanning direction between the p-th raster scan and the (p+q)-th raster scan. In other words, in FIG. 7B, for example, Δx=2 when (x0, y0)=(1, 5), and Δx=1 when (x0, y0)=(11, 5).

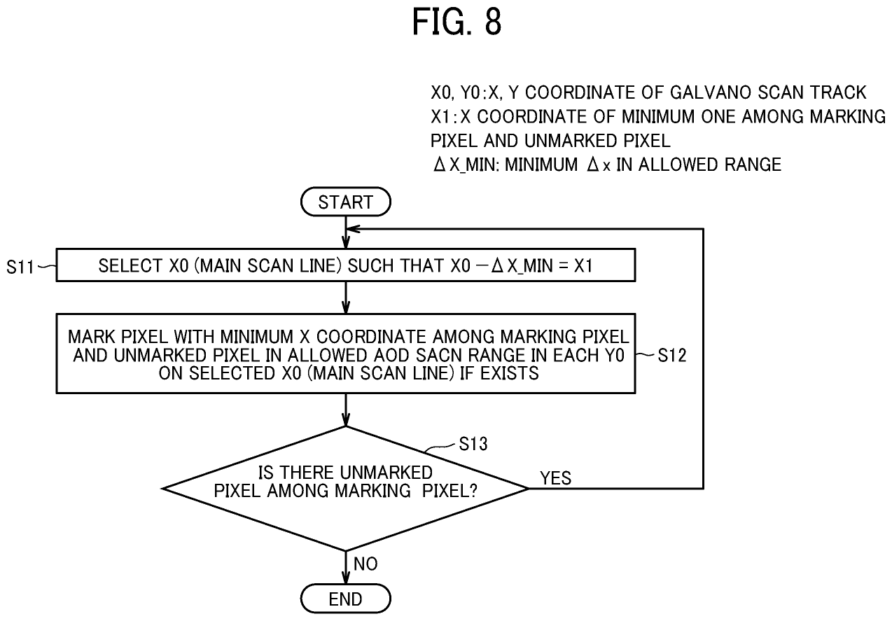

FIG. 8 is a flowchart of marking in this case. The focal length of the fθ lens is 300 mm, the scan angle of view of the AOD 20 is 2 mrad, and the pixel size is 100 μm×100 μm.

The scan track of the laser beam by the galvano scanner 30 is determined such that Δx_min=0. In other words, the scan track of the galvano scanner 30 is determined based on the state in which the AOD 20 deflects the laser beam to the limit toward the −x-side.

When θ=45°, 0≤Δx, and Δy≤4.2 (where Δx=Δy). For example, as illustrated in FIG. 7B, the marking is completed by eight main scans in the marking method illustrated in FIG. 8.

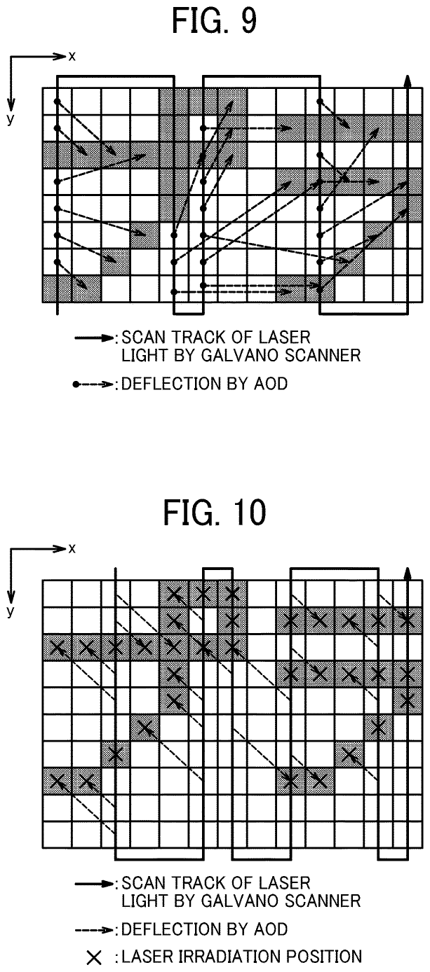

An example of marking of a pattern of 13×8 pixel image illustrated in FIG. 7A using two AODs 20 and 23 will be described with reference to FIG. 9. The solid line represents the scan track by the galvano scanner 30, and the dotted arrows represent the deflection by the AODs 20 and 23.

For simplicity in the drawing, the symbol “x” in the laser irradiation position is omitted. In some cases, the start point and the end point are drawn so as to be shifted from the center of the pixel for convenience such that the dotted arrows do not overlap.

The deflection direction of the AOD 20 is defined as +x-direction, and the deflection direction of the AOD 23 is defined as +y-direction. The focal length of the fθ lens is 300 mm, the scan angle of view of the AOD is 2 mrad, and the pixel size is 100 μm×100 μm as in the example of FIG. 7. At this time, since the scan range is 600 μm and the pixel size is 100 μm, Δx and Δy can be selected from the widths of six pixels.

If the scan track of the galvano scanner 30 is determined such that Δx_min=0 and Δy_min=−3, where Δy_min is the minimum value of Δy, values of 0≤Δx≤6 and −3≤Δy≤3 can be obtained. The number of candidates for deflecting the laser beam by AOD control is increased from 7 pixels in the case of a single AOD to 49 pixels in the case of two AODs.

Since using two AODs 20 and 23 has the degree of freedom of deflection in two directions, the deflection direction can take different values for each pixel as can be understood from FIG. 9. In the drawing method illustrated in FIG. 9, the pattern of 13×8 pixels (eight main scans) illustrated in FIG. 7 can be marked by five main scans. Thus, the drawing method illustrated in FIG. 9 (five main scans) can achieve high-speed marking by 38% as compared with the drawing method illustrated in FIG. 7 (eight main scans). Accordingly, a complicated marking pattern such as a character can be efficiently drawn, and an effect of high-speed scanning can be obtained.

The setting of Δx and Δy and the marking pixel coordinates with respect to each (x0, Y0) in the first two main scans illustrated in FIG. 9 are listed in Table 1.

TABLE 1

| The | Scan track of laser | | | | | |
|---|---|---|---|---|---|---|
| number | beam by galvano | | AOD deflection | | Marking pixel | |
| of main | scanner | | control | | coordinates | |
| scan | x0 | y0 | Δx | Δy | x | y |
| 1 | 1 | 1 | 2 | 2 | 3 | 3 |
| | 1 | 2 | 1 | 1 | 2 | 3 |
| | 1 | 3 | 0 | 0 | 1 | 3 |
| | 1 | 4 | 3 | −1 | 4 | 3 |
| | 1 | 5 | 3 | 1 | 4 | 6 |
| | 1 | 6 | 2 | 1 | 3 | 7 |
| | 1 | 7 | 1 | 1 | 2 | 8 |
| | 1 | 8 | 0 | 0 | 1 | 8 |
| 2 | 5 | 1 | 0 | 0 | 5 | 1 |
| | 5 | 2 | 0 | 0 | 5 | 2 |
| | 5 | 3 | 0 | 0 | 5 | 3 |
| | 5 | 4 | 0 | 0 | 5 | 4 |
| | 5 | 5 | 0 | 0 | 5 | 5 |
| | 5 | 6 | 1 | −3 | 6 | 3 |
| | 5 | 7 | 4 | −3 | 9 | 4 |
| | 5 | 8 | 4 | 0 | 9 | 8 |

The deflection directions of the AODs 20 and 23 are selected to coincide with the main scanning direction and the sub-scanning direction, respectively. However, there is a degree of freedom in the selection of the deflection direction. For example, the deflection direction of the AOD 20 is set to the direction of θ=45° and the deflection angle of the AOD 23 is set to the direction of θ=−45°.

Further, although the number of main scanning can be reduced by using two AODs 20 and 23, the diffraction efficiencies of the AODs 20 and 23 are not 100% (e.g., about 80%). Thus, when the AOD is used as the scanning device, available laser power decreases if the scanning direction is set to two directions (two axes). For example, the available laser power is 80% in the case of a single axis, but the available laser power is 64% in the case of two axes.

Decreasing available laser power is not a problem when there is a margin in the laser power required for marking. However, there is basically a trade-off relation between the laser power and the marking speed. Thus, in order to shorten the marking time, it is not preferable that the available laser power is decreased.

### Marking Using a Single AOD

FIG. 10 is a diagram illustrating an embodiment different from that illustrated in FIG. 9. In an embodiment illustrated in FIG. 10, a single AOD 20 is used to mark the marking pattern (13×8 pixels) illustrated in FIG. 7A. Accordingly, a decrease in laser power can be prevented. For comparison with the embodiments illustrated in FIGS. 7B and 9, the parameters for the fθ lens 40 and the AOD 20, and pixel size are the same as those in FIGS. 7B and 9.

In other words, the focal length of the fθ lens is 300 mm, the scan angle of view of the AOD 20 is 2 mrad, and the pixel size is 100 μm×100 μm. When Δx_min=−2 and θ=45°, −2≤Δx and Δy≤2.2 (where Δx=Δy) are satisfied.

Unlike an embodiment illustrated in FIG. 7B, the main scan range is taken in the +y direction by two pixels more than the length of the image pattern in FIG. 10. Accordingly, the time of a single main scan is lengthened by two pixels, but the pixel (e.g., the (1, 8) pixel or the (2, 8) pixel) originally located at the end in the +y-direction can be drawn from other columns.

As a result, in the marking method illustrated in FIG. 10, marking can be completed by six main scans. The marking flow is the same as that illustrated in FIG. 8. In the embodiment illustrated in FIG. 7B, eight main scans are required. In consideration of the difference in the main scan length, the time required for marking can be reduced by about 6% in the example of FIG. 10 as compared with the example of FIG. 7B (i.e., (a single main scan time magnification)×(ratio of the number of main scan)=(10/8)×(6/8)=0.94).

In the example illustrated in FIG. 10, two pixels are added on the +y-side as compared with the example illustrated in FIG. 9. The number of additional pixel and the additional position are determined by the relation between the image pattern and the scan area of the AOD. Thus, the number of pixel may be more or less than two pixels on the +y-side in FIG. 10, and the additional direction may be on the +y- or −y-side, depending on the relation between the image pattern and the AOD scan area.

In the example illustrated in FIG. 10, a small image of 13×8 pixels is used for simplicity. The shortening time of the marking is at most 6%. However, if the number of main scan time can be reduced to 8/10 times by adding from several to several tens of pixels (e.g., 10 pixels) to the main scan range of, for example, a 500×500 pixel image, the time reduction rate becomes about 18%, and a larger effect can be obtained (i.e., time reduction rate is 18% (510/500×8/10=0.82)).

In the example illustrated in FIG. 10, the deflection angle is set as θ=45° in order to deflect the laser beam to the pixel of (x0+k, y0+k) (k is an integer) with respect to the galvano scan track of (x0, y0) When the pixel is not square, the pixel size in the x-direction is Dx and the pixel size in the y-direction is Dy. As a result, the same effect of shortening the marking time can be obtained by setting the deflection angle of 0=arctan (Dy/Dx).

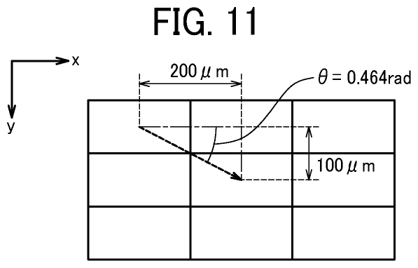

In other words, for example, in the case of the pixel size Dx×Dy=200 μm×100 μm, if 0=arctan (100/200)=0.464 rad, the laser beam can be deflected to the pixel of (x0+k, y0+k) (k is an integer) with respect to the galvano scan track of (x0, y0) (FIG. 11). If 0=arctan (n x Dy/(m×Dx)) and the scan area of the AOD 20 is sufficiently large, any pixel of (x0+m, y0+n) can be drawn with respect to the scan track (x0, y0) of the galvano scanner 30.

Relation between Scan Line Interval of Raster Scan and Irradiation Density of Laser Beam In marking, a gap (pixel gap) caused by a shift in the irradiation position of the laser beam is more noticeable in a portion having a high image area ratio such as a solid image portion. On the other hand, when multiple different deflection devices are used in combination as in the case of a galvano scanner and an AOD, a deviation in the irradiation position of the laser beam may occur if the relative angle in the scanning direction is deviated from the ideal relation. At this time, the larger the deflection angle of the AOD is, the larger the deviation of the irradiation position of the laser beam is.

This can be easily understood from the fact that no deviation of the irradiation position of the laser beam occurs when there is no AOD (i.e., deflection angle θ=0). Further, if the surface irradiated with the laser beam is deviated in the depth direction, the deviation of the irradiation position of the laser beam becomes large. Thus, when the object to be irradiated with the laser beam has a three-dimensional shape, the deviation of the irradiation position of the laser beam is likely to be a problem.

Accordingly, it is conceivable to increase the image quality by narrowing the sub-scan pitch in a region having a high image area ratio and drawing in a region having a smaller AOD deflection angle. In addition, in a region in which the image area ratio is low, the productivity can be increased by widening the sub-scan pitch.

An example of calculation of the irradiation density (J/cm²) of the laser beam is described below. For an irradiation area (pixel) at a coordinate (i, j), a function Z (i, j)=1 in the case where the pixel at (i, j) is a drawing pixel, and in the case where the pixel at (i, j) is not a drawing pixel, Z=0. The irradiation density d (m, n) setting for each irradiation region (m, n) (pixel) is defined by Equation 1 below.

$$d ( m , n ) = {\sum }_{k = 0}^{2} {\sum }_{l = - 1}^{1} Z ( m + k , n + l ) / 9 \qquad Equation 1$$

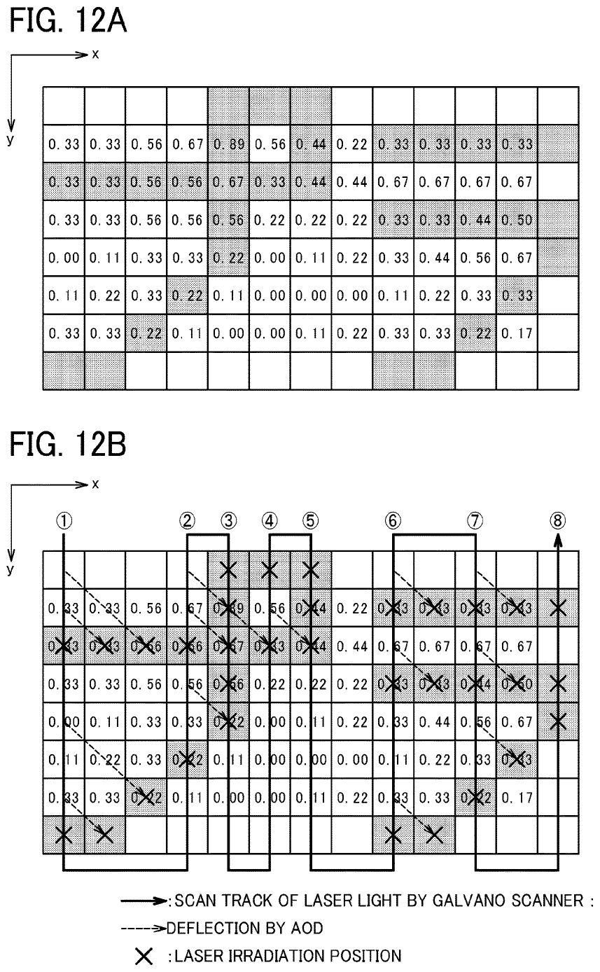

FIG. 12A is a diagram illustrating the irradiation density d (m, n) for each irradiation region, and FIG. 12B is a diagram illustrating a scan track of the laser beam with the same method as illustrated in FIG. 9. The encircled numbers at the upper part of FIG. 12B represent the number of scan, and the encircled numbers 1 to 7 correspond to the first to seventh scans in Table 2

In this example, the calculation region that calculates the irradiation density is a region of 3×3 pixels. However, the calculation region that calculates the irradiation density may be larger or smaller than the area of 3×3 pixels. The calculation region that calculates the irradiation density is not limited to a square, and may be, for example, a rectangle having a long length or a long width.

The minimum x-coordinate to which the laser beam can be deflected (the minimum x-coordinate that can be irradiated with the laser beam) in the i-th main scan is defined as Ai, and the maximum irradiation density Di in the i-th main scan is defined as “the maximum irradiation density in the irradiation region of x=Ai”. In a region in which the image area ratio is high, the effect of increasing the image quality can be obtained by narrowing the sub-scan pitch (scan line interval). Thus, in order to achieve both the image quality and the productivity, it is preferable that Condition (1) below is satisfied in at least two main scans (the k-th and the 1-th scans) until the laser irradiation is completed.

$${D}_{k} > {D}_{l} , and {A}_{k + 1} - {A}_{k} < {A}_{l + 1} - {A}_{l} \qquad Condition ( 1 )$$

The values of Dᵢ and the sub-scan pitch [line] for each scan are listed in Table 2. In this example. Condition (1) described above is satisfied in the combination of k=2 and l=1.

TABLE 2

| Scan | Ai[line] | Di | Sub-scan pitch [line] |
|---|---|---|---|
| 1st scan | 1 | 0.33 | 3 |
| 2nd scan | 4 | 0.67 | 1 |
| 3rd scan | 5 | 0.89 | 1 |
| 4th scan | 6 | 0.56 | 1 |
| 5th scan | 7 | 0.44 | 2 |
| 6th scan | 9 | 0.67 | 2 |
| 7th scan | 11 | 0.67 | 2 |

In the present disclosure, for example, the following aspects can be achieved by utilizing the relation between the scan line interval and the irradiation density. Aspect A A laser marking method uses a first deflector and a second deflector. The first deflector deflects a laser beam, and the second deflector raster-scans a laser irradiation object having a yet-to-be irradiated region and a non-irradiation region with the laser beam deflected by the first deflector as a raster-scanning to irradiate the laser irradiation object with the laser beam. The first deflector deflects the laser beam moving to the non-irradiation region of the laser irradiation object in the raster-scanning, to the yet-to-be irradiated region separated from the non-irradiation region. A scan line interval in the raster-scanning is determined by a density of a laser irradiation region per reference area of the laser irradiation object.

### Aspect A′

A laser marking method uses a first deflector and a second deflector. The first deflector deflects a laser beam, and the second deflector raster-scans a laser irradiation object having a yet-to-be irradiated region and a non-irradiation region with the laser beam deflected by the first deflector as a raster-scanning to irradiate the laser irradiation object with the laser beam. The laser marking method includes calculating an irradiation density per area for each laser irradiation region before laser irradiation. The first deflector deflects the laser beam moving to the non-irradiation region of the laser irradiation object in the raster-scanning, to the yet-to-be irradiated region separated from the non-irradiation region. The minimum x-coordinate to which the laser beam can be deflected (the minimum x-coordinate that can be irradiated with the laser beam) in the i-th main scan is defined as Ai, and the maximum irradiation density Dᵢ in the i-th main scan is defined as the maximum irradiation density in the irradiation region of x=Ai. A scan line interval is determined such that in at least two different scans (k-th and i-th), Condition (1) below is satisfied.

$${D}_{k} > {D}_{l} , and {A}_{k + 1} - {A}_{k} < {A}_{l + 1} - {A}_{l} \qquad Condition ( 1 )$$

### Aspect B

A laser irradiation device includes a first deflector to deflect a laser beam and a second deflector to raster-scan a laser irradiation object having a yet-to-be irradiated region and a non-irradiation region with the laser beam deflected by the first deflector as a raster-scanning to irradiate the laser irradiation object with the laser beam. The first deflector deflects the laser beam moving the non-irradiation region of the laser irradiation object in the raster-scanning, to the yet-to-be irradiated region separated from the non-irradiation region. A scan line interval in the raster-scanning is determined by a density of a laser irradiation region per reference area of the laser irradiation object.

### Aspect B′

A laser irradiation device includes a first deflector to deflect a laser beam and a second deflector to raster-scan a laser irradiation object having a yet-to-be irradiated region and a non-irradiation region with the laser beam deflected by the first deflector as a raster-scanning to irradiate the laser irradiation object with the laser beam. The laser marking device further includes a irradiation density calculation unit to calculate an irradiation density per area for each laser irradiation region before laser irradiation. The first deflector deflects the laser beam moving to the non-irradiation region of the laser irradiation object in the raster-scanning, to the yet-to-be irradiated region separated from the non-irradiation region. The minimum x-coordinate to which the laser beam can be deflected (the minimum x-coordinate that can be irradiated with the laser beam) in the i-th main scan is defined as Ai, and the maximum irradiation density Dᵢ in the i-th main scan is defined as the maximum irradiation density in the irradiation region of x=Aᵢ. A scan line interval is determined such that in at least two different scans (k-th and i-th), Condition (1) below is satisfied.

$${D}_{k} > {D}_{l} , and {A}_{k + 1} - {A}_{k} < {A}_{l + 1} - {A}_{l} \qquad Condition ( 1 )$$

### Aspect C

A laser marking device includes a first deflector to deflect a laser beam and a second deflector to raster-scan a laser irradiation object having a yet-to-be irradiated region and a non-irradiation region with the laser beam deflected by the first deflector as a raster-scanning to irradiate the laser irradiation object with the laser beam. The first deflector deflects the laser beam moving the non-irradiation region of the laser irradiation object in the raster-scanning, to the yet-to-be irradiated region separated from the non-irradiation region. A scan line interval in the raster-scanning is determined by a density of a laser irradiation region per reference area of the laser irradiation object.

### Aspect C′

A laser marking device includes a first deflector to deflect a laser beam and a second deflector to raster-scan a laser irradiation object having a yet-to-be irradiated region and a non-irradiation region with the laser beam deflected by the first deflector as a raster-scanning to irradiate the laser irradiation object with the laser beam. The laser marking device further includes a irradiation density calculation unit to calculate an irradiation density per area for each laser irradiation region before laser irradiation. The first deflector deflects the laser beam moving to the non-irradiation region of the laser irradiation object in the raster-scanning, to the yet-to-be irradiated region separated from the non-irradiation region. The minimum x-coordinate to which the laser beam can be deflected (the minimum x-coordinate that can be irradiated with the laser beam) in the i-th main scan is defined as Ai, and the maximum irradiation density Di in the i-th main scan is defined as the maximum irradiation density in the irradiation region of x=Aᵢ. A scan line interval is determined such that in at least two different scans (k-th and i-th), Condition (1) below is satisfied.

$${D}_{k} > {D}_{l} , and {A}_{k + 1} - {A}_{k} < {A}_{l + 1} - {A}_{l} \qquad Condition ( 1 )$$

### Deflection Angle θ

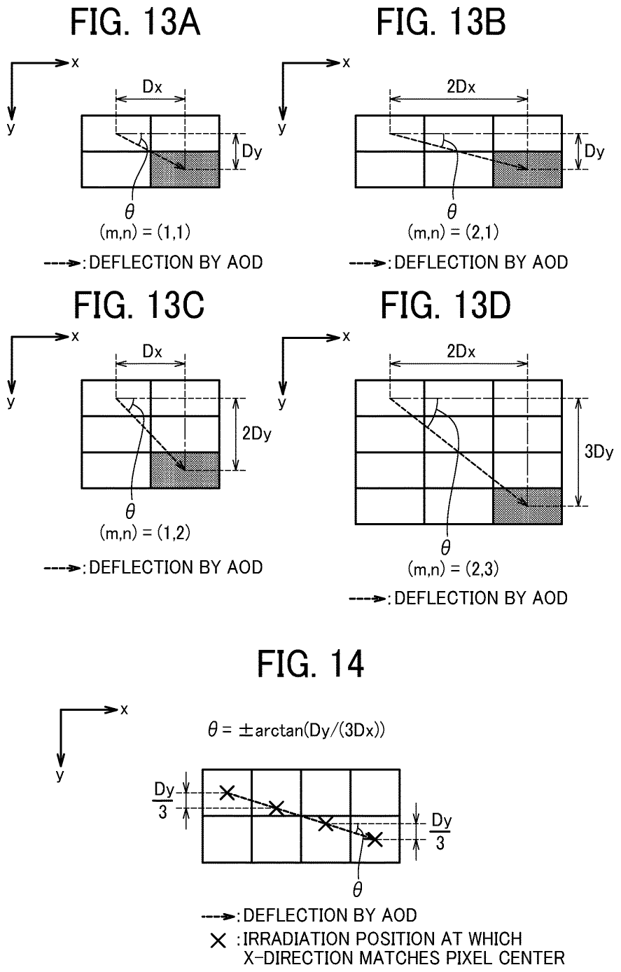

Referring to FIGS. 13A to 13D, examples of deflecting the laser beam from the (1, 1) pixel to the (1+m, 1+n) pixel will be described for each region of (m, n)=(1, 1), (2, 1), (1, 2), and (2, 3). The relative angle (deflection angle θ) between the main scanning direction and the AOD deflection direction of the galvano scanner 30 is set in the manner illustrated in FIGS. 13A to 13D. Accordingly, the laser beam can be deflected from the center of the (x0, y0) pixel of the scan track of the galvano scanner 30 to the center of the (x0+m, y0+n) pixel, and thus, highly accurate laser marking can be performed.

As a method of adjusting the deflection angle θ, in addition to the method that rotates the AOD deflection direction around the z-axis as illustrated in FIG. 1, a method that rotates the galvano scanner 30 around the z-axis, or a method that rotates the scanning direction of the galvano scanner 30 without changing the optical system can be used. Since an incident light beam that goes in the AOD 20 has a predetermined polarization direction with respect to the AOD 20, when the AOD 20 is rotated, the polarization of the incident light beam is also rotated depending on the rotation of the AOD 20 using, for example, a half wave plate.

For example, when θ=arctan (Dy/(3 Dx)), and the laser beam position is deflected from the pixel (x0, y0) to the center of another pixel, the laser beam can be deflected only to the pixel represented by (x0+3k, y0+k), where k is an integer. However, this limitation can be relaxed by allowing the deviation of the marking position. In other words, as illustrated in FIG. 14, the laser beam at the pixel (x0, y0) can be deflected also to the pixels represented by (x0+3k−2, y0+k−1) and (x0+3k−1, y0+k), where k is an integer, by allowing the deviation of the irradiation position of Dy/3 in the y-direction, where Dy is the pixel size in the y-direction.

### Allowance of Deviation of Marking Position

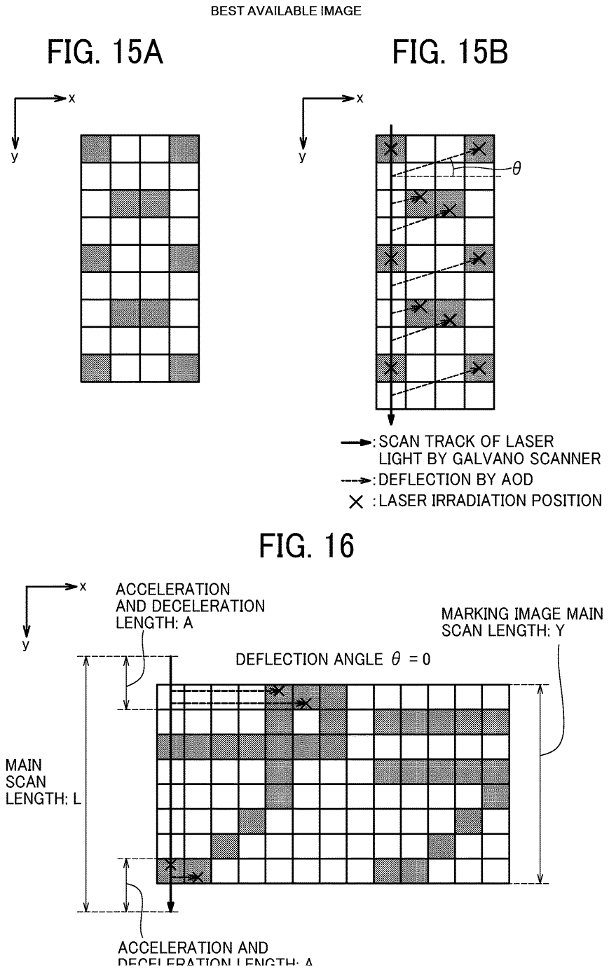

When the deviation of the marking position is allowed as illustrated in FIG. 14, the marking speed can be increased (high-speed marking). The high-speed marking will be described with reference to the specific image pattern illustrated in FIG. 15A. FIG. 15A is a diagram illustrating an example of marking of a 4×9 pixel image pattern.

In the present example, θ=arctan (−Dy/(3 Dx)). FIG. 15B is a diagram illustrating a scan track of the laser beam by the galvano scanner 30 (solid arrow) and a deflection by the AOD 20 (dashed arrow) at the time of marking. The values Δx and Δy of the AOD deflection control for each (x0, y0) and x- and y-coordinates of the marking pixel at the time are listed in Table 3 below.

TABLE 3

| The | Scan track of laser | | | | | |
|---|---|---|---|---|---|---|
| number | beam by galvano | | AOD deflection | | Marking pixel | |
| of main | scanner | | control | | coordinates | |
| scan | x0 | y0 | Δx | Δy | x | y |
| 1 | 1 | 1 | 0 | 0 | 1 | 1 |
| | 1 | 2 | 3 | −1 | 4 | 1 |
| | 1 | 3 | 1 | −1/3 | 2 | 8/3 |
| | 1 | 4 | 2 | −2/3 | 3 | 10/3 |
| | 1 | 5 | 0 | 0 | 1 | 5 |
| | 1 | 6 | 3 | −1 | 4 | 5 |
| | 1 | 7 | 1 | −1/3 | 2 | 20/3 |
| | 1 | 8 | 2 | −2/3 | 3 | 22/3 |
| | 1 | 9 | 0 | 0 | 1 | 9 |
| | 1 | 10 | 3 | −1 | 4 | 9 |

When the marking pixel coordinates are fractional, for example, y=8/3 represents a marking pixel position deviated from the pixel center, as in “a position deviated from the pixel center of y=3 by Dy/3 to the −y-side”, where Dy is the pixel size in the y-direction. Marking is performed as illustrated in FIG. 15B so that marking can be completed by a single main scan. However, the example illustrated in FIG. 15B, like the example in FIG. 10, takes a main scan region of one pixel additionally on the +y-side.

The case where the laser irradiation pitch calculated from the galvano main scanning speed and the repetition frequency is equal to the pixel size, i.e., the case where the number of laser irradiation is one while the galvano scan track passes through a single pixel (and one pixel can be marked with one pulse) has been described above, but the other cases will also be described.

### Acceleration or Deceleration of Main Scanning Speed

The galvano scanner 30 is accelerated to increase the main scanning speed sufficiently. When L−2A<Y, where A is the length required for acceleration (deceleration), L is the length of the main scanning direction, and Y is the length of the marking image in the main scanning direction, the galvano scanner 30 is not sufficiently accelerated at the end of the image region in the main scanning direction. Thus, there is a case where twice or more of laser beam irradiation can be performed while the galvano scan track with insufficient acceleration passes through a single pixel.

For example, when L, A, and Y have the relation illustrated in FIG. 16 (the image size is 13×8 pixels), the galvano scanner 30 is not sufficiently accelerated and is at a low speed in the range of A at the upper and lower ends. Accordingly, there is a case where twice or more of laser beam irradiation can be performed while the galvano scan track passes through the pixels of y=1 (non-irradiated region) and y=8 (irradiated region).

Different deflection controls (Δx, Δy) are applied to multiple laser emissions at y=1 and 8 by the AOD 20. Accordingly, for example, two pixels can be marked while the galvano scan track passes through a single pixel. As a result, the marking time may be reduced.

FIG. 16 is a diagram illustrating an example of a marking method to mark two pixels when the galvano scan track through a single pixel. In other words, with the deflection angle θ=0, two pixels (yet-to-be irradiated regions) of (5, 1) and (6, 1) are marked in the pixel (non-irradiated region) of (x0, y0)=(1, 1). Similarly, in the pixel of (x0, y0)=(1, 8) (irradiation region), two pixels of the pixel (1, 8) (irradiation region) and the pixel (2, 8) (yet-to-be irradiated region) are marked. Since the irradiation timings for the two pixels are different from each other, the irradiation positions are shifted in the main scanning direction.

### Marking Using Two AODs

When two AODs 20 are used for two-dimensional deflection, such a deviation in the main scanning direction can be prevented. Although twice irradiation is described in the example for simplicity, the number of irradiation may be more than two. The number of pixel (x0, y0) that can be irradiated with the laser beam multiple times also varies in relation to the acceleration or deceleration length and the pixel size.

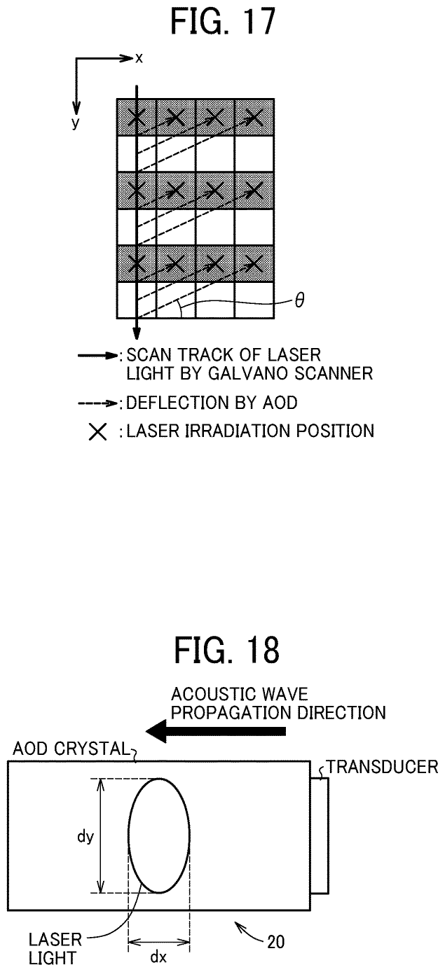

Alternatively, for example, the laser irradiation pitch calculated from the galvano main scanning speed and the repetition frequency is set to one half of the pixel size. Accordingly, a method of marking two pixels while the laser beam passes through a single pixel as illustrated in FIG. 16 can be also used. In FIG. 17, θ=arctan (−Dy/2Dx).

Although the laser irradiation pitch is set to be half of the pixel size as an example, the laser irradiation pitch may be smaller than half of the pixel size. In such a case, two or more pixels can be marked while the laser beam passes through a single pixel.

### Acoustic Wave Beam of AOD

As illustrated in FIG. 18, in the AOD 20, an acoustic wave is induced in the AOD crystal by a transducer (vibrator) as an actuator disposed at one end of the AOD crystal, and the laser beam is diffracted by a refractive index distribution generated in the AOD crystal by the acoustic wave. The diameter of the acoustic wave beam in the direction of propagation of the acoustic wave is dx, and the diameter of the acoustic wave beam in the direction perpendicular to the direction of propagation of the acoustic wave is dy.

When the acoustic wave (acoustic wave signal) is not transmitted to the whole laser beam, the laser beam is not sufficiently diffracted. Thus, the response speed of the AOD 20 is approximately dx/V, where V is the sound velocity in the crystal. The smaller the beam diameter, the faster the control (high-speed deflection) can be performed.

However, when a high-power laser is used and the beam diameter is formed to be small, the light intensity becomes so high that the high light intensity may cause a problem in light resistance of each optical device. Thus, the light intensity can be reduced while maintaining the high-speed deflection response, and the high-speed deflection response and the light resistance of the optical device can be compatible by setting dy>dx.

### Laser Irradiation Control Unit and Laser Scanning Control Unit

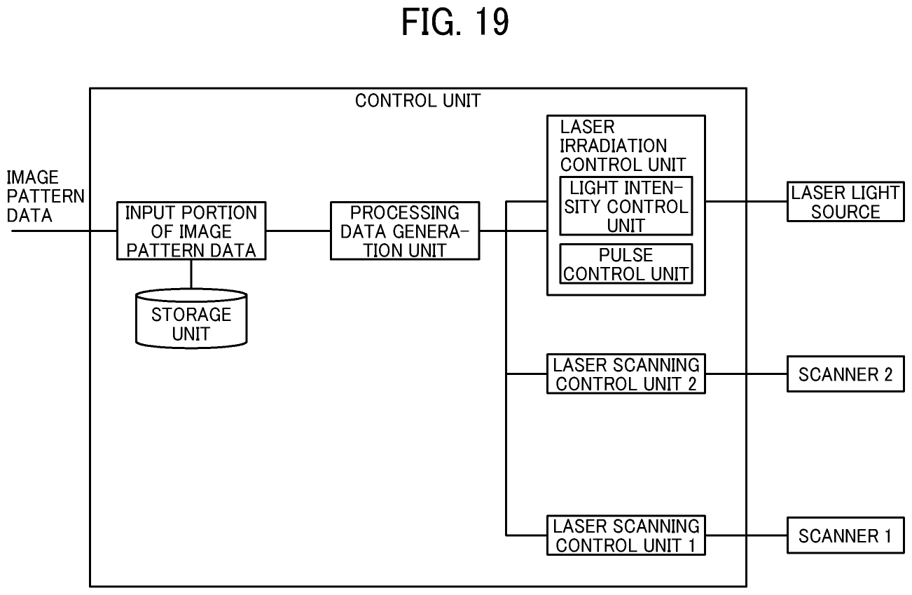

FIG. 19 is a block diagram illustrating a laser irradiation control unit and a laser scanning control unit. The scanner 1 corresponds to, for example, the AOD 20 as a first deflector or a first scanning device, and the scanner 2 corresponds to, for example, the galvano scanner 30 as a second deflector or a second scanning device.

### Method of Controlling AOD

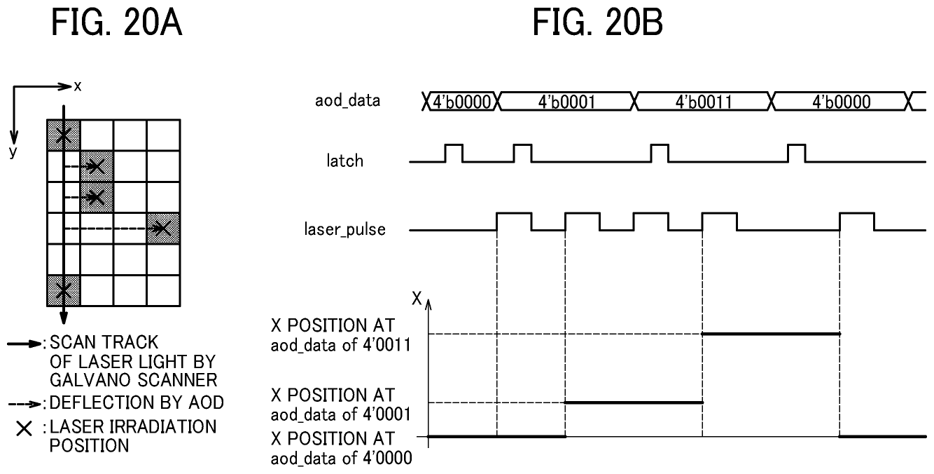

A method of controlling the AOD 20 will be described with reference to the marking example (laser turns on five times) illustrated in FIG. 20A FIG. 19B is a timing chart of the AOD control. The aod_data signal is a frequency value (4 bits in this case) of the RF signal applied to the AOD element, and the value of the frequency is reflected to the AOD element by the latch signal.

The laser beam is turned on at the timing of the laser_pulse signal. The laser beam is deflected in the x-direction by the AOD element at an angle corresponding to the frequency value set at a time when the laser beam is turned on.

The correspondence between the value of aod_data and the displacement Δx due to deflection is as illustrated in Table 4 below. In order to adjust the timing of turning on the laser and the timing of deflection by the AOD 20, it is preferable to adjust the time between the laser_pulse signal and the latch signal.

TABLE 4

| aod_data | Δx |
|---|---|
| 4′b0000 | 0 |
| 4′b0001 | 1 |
| 4′b0010 | 2 |
| 4′b0011 | 3 |

In the deflection angle control of the AOD 20, there is a limitation on a response characteristics as an AOD element (e.g., the sound velocity and the beam diameter, or a restriction of a response time due to electrical characteristics of the control unit). When the pulse turning-on interval (the reciprocal of the repetition frequency) of the laser is T[s] and the time required for the deflection angle control of the AOD 20 is τ[s], if T>τ, the deflection angle can be controlled independently for each laser pulse, so that the degree of freedom is high and the effect of high-speed marking is large.

When T<τ, the time required for the deflection angle control is longer than the pulse turning-on interval. Thus, the pulse is discarded at the time of deflection angle control. In other words, the pulse is not turned on at a timing when the pulse can be turned on. In this case, the effect of high-speed marking may be obtained by performing control with the number of deflection angle change as small as possible.

### Fabricating Apparatus

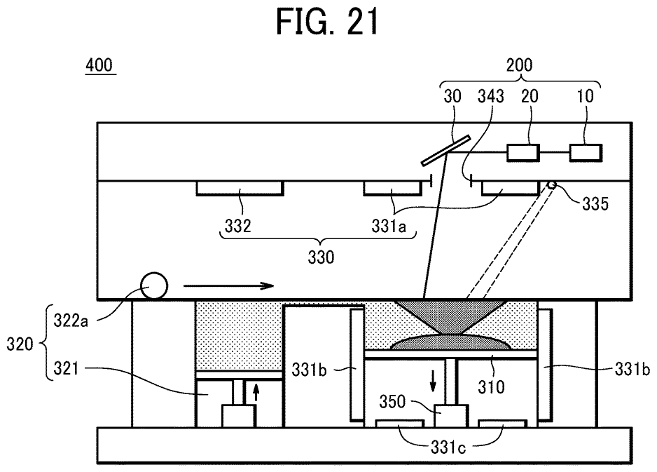

The laser irradiation device according to an embodiment of the present disclosure can be applied to a fabricating apparatus for a three-dimensional article (three-dimensional fabricating apparatus). FIG. 21 is a diagram illustrating a powder bed fusion apparatus 400 as an example of a three-dimensional fabricating apparatus.

A powder bed fusion apparatus 400 fabricates a three-dimensional article by fusing and bonding a predetermined irradiation region of a powder bed irradiated with the laser beam. The powder bed is formed by multiple powder layers irradiated with the laser beam in order. Specifically, the powder material is spread flat to form a layer. A predetermined position of the layer is irradiated with the laser beam, and the particles contained in the powder material are selectively sintered or melted to bond the particles.

Accordingly, a single layer is formed as one layer (fabricated layer) of multiple layers to be formed the three-dimensional article. In other words, when the three-dimensional articles is divided in the thickness direction, one layer is obtained. A powder material is further spread on the fabricated layer formed described above, and the following fabricated layer is formed by laser beam irradiation.

This procedure is repeated, and the fabricated layers are stacked. As a result, a three-dimensional fabricated article is produced. The powder material includes a resin material or a metal material, and two or more of these materials may be mixed as appropriate, and an additive may be further added.

The powder bed fusion apparatus 400 includes a fabricating stage 310, a layer forming unit 320, a preheating unit 330, a thermometer 335, and a laser irradiation device 200. The fabricating stage 310 is a stage on which a three-dimensional article is fabricated. The stage support 350 supports the fabricating stage 310 so that the position of the fabricating stage 310 is movable in the vertical direction.

The fabricating stage 310 is configured to be precisely movable in the vertical direction by the stage support 350. As the stage support 350, various configuration can be applied. For example, the stage support includes a holding unit that holds the fabricating stage 310, a guide that guides the holding unit in the vertical direction, and a ball screw engaged with a screw hole of the guide unit.

The layer forming unit 320 forms a layer. The layer forming unit 320 includes a powder supply 321 that supplies powder and a recoater 322a that flattens the powder of the fabricating stage 310.

The layer forming unit 320 has, for example, an edge of an opening through which the fabricating stage 310 rises and falls, an opening having the edge on substantially the same plane in the horizontal direction, and includes a powder material storage extending downward in the vertical direction from the opening. The powder supply 321 includes a supply piston disposed at the bottom of the powder material storage, and the supply piston rises and falls in the opening. The powder supply 321 may include a powder material storage and a nozzle disposed in the upper vertical direction with respect to the fabricating stage, and discharge the powder material on the same plane as the fabricating stage 310 in the horizontal direction.

The preheating unit 330 pre-heats the layer formed in the layer forming unit 320. The preheating unit 330 may be any unit that can heat at least a region in which the fabricated layer is to be formed on the surface of the layer and maintain the temperature of the region.

For example, the preheating unit 330 may include a first heater 331a that can heat the surface of the layer formed on the fabricating stage 310, or may further include a second heater 332 that heats the powder material before being supplied onto the fabricating stage. The preheating unit 330 may be configured to selectively heat a region in which a fabricated layer is to be formed, or may be configured to heat the entire inside of the apparatus and adjust the temperature of the surface of the formed layer to a predetermined temperature.

The first heater 331 includes multiple first heaters 331a, 331b, and 331c. The first heater 331a may heat the layer from the top surface, the first heater 331b may heat the layer from the side surface, and the first heater 331c may heat the layer from the bottom surface. Further, any combination of the multiple first heaters 331a, 331b, and 331c may be used. However, the surface temperature of the layer is likely to increase in the vicinity of the first heater 331a, 331b, and 331c, and the surface temperature of the layer is less likely to increase as the distance from the first heater 331a, 331b, and 331c increases.

Thus, in order to prevent temperature unevenness on the surface of the layer and deformation of the fabricated layer due to the temperature unevenness on the surface of the layer, it is preferable that each of the first heater 331a, the first heater 331b, and the first heater 331c includes multiple heaters (i.e., multiple first heaters 331a, multiple first heaters 331b, and multiple first heater 331c). It is preferable that the multiple first heaters 331a are disposed so as to be separated from each other, the multiple first heaters 331b are disposed so as to be separated from each other, and the multiple first heater 331c are disposed so as to be separated from each other. At this time, it is preferable that the multiple first heaters 331a are arranged at equal intervals, the multiple first heaters 331b are arranged at equal intervals, and the multiple first heaters 331c are arranged at equal intervals.

The thermometer 335 measures the temperature of the layer. The thermometer 335 may be any device that can measures the surface temperature of the region in which the fabricated layer is to be formed in a non-contact manner. For example, an infrared sensor or an optical pyrometer may be used.

The laser irradiation device 200 irradiates the powder bed with laser beam. The fabricated layer is formed by irradiating with the laser beam. The laser irradiation device 200 includes a laser oscillator 10, an AOD 20, and a galvano scanner 30.

The laser irradiation device 200 may include a laser window 343 through which the laser beam passes. The laser window 343 may be made of any material that allows laser beam to pass therethrough.

In the three-dimensional fabricating apparatus (powder bed fusion apparatus 400), if the preliminary temperature heated by the preheating unit 330 is uneven, the rate of change in the volume (specific volume) of the powder irradiated with the laser beam is also uneven, and the accuracy of the three-dimensional fabricated article is lowered. Thus, the temperature is measured by the thermometer 335, and the energy of the laser beam with which the laser irradiation device 200 irradiates the power is adjusted based on the measured temperature.

Specifically, the energy given from the laser beam to the particles as the irradiated portion is increased when the preheating temperature is low, and the energy given from the laser beam to the particles as the irradiated portion is decreased when the preheating temperature is high.

The laser irradiation device 200 controls an irradiation device and a scanner such that when the scanner scans two or more irradiation regions and a non-irradiation region sandwiched between the irradiation regions, the irradiation device and the scanner scan at a constant speed in the irradiation region and change the scanning speed in the non-irradiation region. In other words, in order to increase or decrease the energy by laser irradiation, the laser irradiation device 200 controls the energy by laser irradiation received by the particles per unit time by changing the scanning speed of laser scan.

The laser irradiation device 200 illustrated in FIG. 21 can control the scanning speed with high accuracy for each irradiation region, and the energy of the laser beam for sintering or dissolving the powder particles can be controlled with high accuracy. As a result, the rate of change in the volume (specific volume) of the resin due to unevenness in the preliminary temperature can be uniformed, and the accuracy of the three-dimensional article due to the unevenness can be prevented from being lowered. According to an embodiment of the present disclosure, the laser output can be effectively used and the productivity can be increased in the raster scan of the laser beam.

Embodiments of the present disclosure have been described in detail above, but embodiments of the present disclosure is not limited to the embodiments described above, and various modifications may be made within the scope of the technical ideas described in the claims. In an embodiment described above, the case where the first order diffraction light beam by AOD 20 has been described as an example. However, the same effect can be obtained even if the second or more order diffraction light beam is used. Further, a combination of light beams having multiple orders can be used. For example, both a zero order light beam and a first order light beam can be combined to use.

### Aspect

Aspects of the present disclosure are, for example, as follows.

### First Aspect

A laser irradiation method includes deflecting a laser beam by a first deflector, raster-scanning a laser irradiation object having a yet-to-be irradiated region and a non-irradiation region with the laser beam deflected by the first deflector by a second deflector, and deflecting the laser beam moving to the non-irradiation region in the raster-scanning to the yet-to-be irradiated region separated from the non-irradiation region to irradiate.

### Second Aspect

In the laser irradiation method according to the first aspect, the yet-to-be irradiated region is separated from a scanning direction in the raster-scanning.

### Third Aspect

In the laser irradiation method according to the first or second aspect, the first deflector includes an acousto-optic deflector or an electro-optic deflector.

### Fourth Aspect

In the laser irradiation method according to any one of the first to third aspects, the first deflector deflects a laser beam in a direction different from a scanning direction in the raster-scanning.

### Fifth Aspect

The laser irradiation method according to any one of the first to fourth aspects further includes deflecting a laser beam deflected by the first deflector in a first direction in a second direction different from the first direction by a third deflector between the first deflector and the second deflector.

### Sixth Aspect

In the laser irradiation method according to any one of the first to fifth aspects, a scan line interval in the raster-scanning is determined based on an irradiation density of a laser irradiation region per reference area in the laser irradiation object.

### Seventh Aspect

A laser marking method includes deflecting a laser beam by a first deflector, raster-scanning a laser irradiation object having an irradiation region and a non-irradiation region with the laser beam deflected by the first deflector by a second deflector, and deflecting the laser beam moving to the irradiation region or the non-irradiation region in the raster-scanning to a yet-to-be irradiated region separated from the irradiation region or the non-irradiation region when a raster-scanning speed increases or decreases.

### Eighth Aspect

The laser marking method according to the seventh aspect further includes deflecting a laser beam deflected by the first deflector in a first direction in a second direction different from the first direction by a third deflector between the first deflector and the second deflector, and decreasing a positional deviation of a laser irradiation position in a raster-scanning direction to the yet-to-be irradiated region.

### Ninth Aspect

A laser irradiation device includes a first deflector to deflect a laser beam, and a second deflector to raster-scan a laser irradiation object having a yet-to-be irradiated region and a non-irradiation region with the laser beam deflected by the first deflector as a raster-scanning. The first deflector deflects the laser beam moving to the non-irradiation region in the raster-scanning to the yet-to-be irradiated region separated from the non-irradiation region.

### Tenth Aspect

In the laser irradiation device according to the ninth aspect, the yet-to-be irradiated region is separated from a scanning direction of the raster-scanning.

### Eleventh Aspect

In the laser irradiation device according to the ninth aspect or tenth aspect, the first deflector includes an acousto-optic deflector or an electro-optic deflector.

### Twelfth Aspect

In the laser irradiation device according to any one of the ninth to eleventh aspects, the first deflector deflects a laser beam in a direction different from the scanning direction of the raster-scanning.

### Thirteenth Aspect

The laser irradiation device according to any one of the ninth to twelfth aspects, further includes a third deflector between the first deflector and the second deflector, to deflect the laser beam deflected by the first deflector in a first direction in a second direction different from the first direction.

### Fourteenth Aspect

A laser marking device includes a first deflector to deflect a laser beam, and a second deflector to raster-scan a laser irradiation object having an irradiation region and a non-irradiation region with the laser beam deflected by the first deflector as a raster-scanning. The first deflector deflects the laser beam moving to the irradiation region or the non-irradiation region in the raster-scanning to a yet-to-be irradiated region separated from the irradiation region or the non-irradiation region when the raster-scanning accelerates or decelerates.

### Fifteenth Aspect

The laser marking device according to the fourteenth aspect, further includes a third deflector between the first deflector and the second deflector, to deflect a laser beam deflected by the first deflector in a first direction in a second direction different from the first direction, and decrease a positional deviation of a laser irradiation position in a raster-scanning direction to the yet-to-be irradiated region.

### Sixteenth Aspect

In the laser illumination device according to any one of the ninth to fifteenth aspects, a first deflection angle of a laser beam deflected by the first deflector at a predetermined coordinate of a p-th raster scan in a raster-scanning direction is different form a second deflection angle of the laser beam deflected by the first deflector at a predetermined coordinate of a (p+q)-th raster scan in a raster-scanning direction, where p and q are any integers.

### Seventeen Aspect

A fabricating apparatus includes the laser irradiation device according to any one of the ninth to sixteenth aspects, to irradiate a powder layer with a laser beam to fabricate a fabricated layer, and a control unit to control the laser irradiation device to repeatedly fabricate the fabricated layer to fabricate a three-dimensional article.

### Eighteenth Aspect

A laser marking device includes a light source to emit a laser beam, a first scanner to scan an object with the laser beam, and a second scanner to scan an object with the laser beam, and performs marking to a marking object. The second scanner raster-scans the marking object with the laser beam to form a marking pattern. The marking pattern includes multiple main scan lines including at least a first main scan line and a second main scan line. The first main scan line includes a first irradiation position, and the second main scan line includes a second irradiation position. The first irradiation position is irradiated with the laser beam and the second irradiation position is irradiated with the laser beam by controlling a deflection angle of the first scanner.

### Nineteenth Aspect

In the laser marking device according to the eighteenth aspect, a main scan axis of the second scanner coincides with any one of the multiple main scan lines of a marking image when the deflection angle of the first scanner is a reference value. The first deflector deflects the laser beam to a drawing pixel on a drawing line different from the main scan axis.

### Twentieth Aspect

In the laser making device according to the eighteenth or nineteenth aspect, a main scanning direction and a sub-scanning direction of the second scanner are x, and y, respectively. The sub-scanning direction of the second scanner is from the minus-direction to the plus direction of x. The pixel having the minimum x (this x-coordinate of is x1) among marking pixels that can be marked in at least one y line is marked, and a pixel having an x-coordinate different from x1 in at least one different y in the same main scan is marked.

### Twenty-First Aspect

In the laser marking device according to the twentieth aspect, in at least one main scan, the minimum x-coordinate that can be marked and is determined by a relation between a deflection range of the first scanner and a deflection angle of the second scanner coincides with a x-coordinate among pixels that has not been marked at the time of main scan.

### Twenty-Second Aspect

In the laser marking device according to any one of the eighteenth to twenty-first aspects, the first deflector includes an acousto-optic deflector or an electro-optic deflector.

### Twenty-Third Aspect

In the laser marking device according to any one of the eighteenth to twenty-second aspects, the first deflector deflects the laser beam in a single direction According to the twenty-third aspect, the light utilization efficiency is increased, and the available laser power for the marking can be increased.

### Twenty-Fourth Aspect

In the laser marking device according to the twenty-third aspect, the second scanner can deflect the laser beam in two directions. When an angle formed by the scanning direction of the first scanner and the sub-scanning direction of the second scanner is defined as an angle θ, a size in the sub-scanning direction in the marking image region is larger than a value that multiplies a scan length of the second scanner by cos (0).

### Twenty-Fifth Aspect

In the laser marking device according to the twenty-third or twenty-fourth aspect, the angle θ is given by the equation of θ=+arctan ((nDy)/(mDx), where Dy [m] is a dot interval in the main scanning direction, Dx [m] is a dot interval in the sub-scanning direction, n and m are natural numbers. According to the twenty-fifth aspect, since the angle θ is given by the equation, a coordinate to which the AOD deflects the laser beam coincides with the position of the marking pixel.

### Twenty-Sixth Aspect

In the laser marking device according to the twenty-third or twenty-fifth aspect, the angle θ is determined based on the image pattern. The deflection direction of the first scanner is different from a direction of the longest line in the image pattern. According to the twenty-sixth aspect, since there is a suitable deflection direction depending on the drawing pattern, the effect of high-speed marking is increased by determining the direction depending on the image pattern. For example, for a pattern having many transverse lines, the deflection direction is shifted from 0° (transverse direction so that the speed can be increased.

### Twenty-Seventh Aspect

In the laser marking device according to any one of the eighteenth to twenty-sixth aspects, a deflection angle by the first deflector is a first deflection angle, a deflection angle at which a n-th pixel is drawn is a, a deflection angle at which (n+1)-th pixel is drawn is b. While the n-th pixel is drawn and (n+1)-th pixel is drawn, the first deflection angle satisfies a condition of a≤(first deflection angle)<b, if a<b, and the first deflection angle satisfies a condition a≥(first deflection angle)≥b, if a>b, where n is time order of drawing pixel. According to the twenty-seventh aspect, the deflection angle can be controlled at the minimum processing time.

### Twenty-Eighth Aspect

In the laser marking device according to any one of the eighteenth to twenty-seventh aspects, a time requiring for changing the deflection angle from drawing a pixel to drawing a following pixel is equal to or less than a laser turning-on period. According to the twenty-eighth aspect, deflection angle modulation by the first scanner can be set independently to all pulses of the laser beam. If this relation is not satisfied, two or more pulses are continuously drawn at the same deflection angle, and at least one pulse is discarded (not used for drawing) when the deflection angle is changed.

### Twenty-Ninth Aspect

In the laser marking device according to any one of the twenty-fifth to twenty-eighth aspects, the deflection angle θ has a predetermined value other than 0. According to the twenty-ninth aspect, the laser marking device has an advantage in writing a transverse line.

### Thirtieth Aspect

In the laser marking device according to any one of the eighteenth to twenty-ninth aspects, the laser light source can emit a laser beam more times than the number of pixel through which the laser beam track generated by the second deflector passes when the second scanner accelerates or decelerates the scan in the main scanning direction. The deflection angle for each laser beam is controlled, and each laser beam moves to a different marking point one another. According to the thirtieth aspect, since the AOD picks up the laser pulse that is typically discarded in the non-constant velocity region and effectively uses the laser pulse for marking, the high-speed marking can be achieved.

### Thirty-First Aspect

In the laser marking device according to any one of the eighteenth to thirtieth aspects, the first scanner includes an acousto-optic deflector. The laser beam that goes in the first scanner has a diameter in a deflection direction smaller than a diameter in a direction perpendicular to the deflection direction. According to the thirty-first aspect, both the light resistance of each optical device and the high-speed response for the AOD can be achieved.

### Thirty-Second Aspect

A laser irradiation method includes causing a first deflector to deflect a laser beam, causing a second deflector to raster-scan an object with the laser beam deflected by the first deflector, the object having an irradiation region and a non-irradiation region separated from the irradiation region, and causing the first deflector to deflect the laser beam, which is moved to the non-irradiation region by the second deflector, to the irradiation region to irradiate the irradiation region with the laser beam.

### Thirty-Third Aspect

In the laser irradiation method according to the thirty-second aspect, the causing the second deflector to raster-scan the object with the laser beam in a main scanning direction, and the causing the first deflector to deflect the laser beam in a sub-scanning direction intersecting the main-scanning direction to irradiate the irradiation region separated from the non-irradiation region in the sub-scanning direction.

### Thirty-Fourth Aspect

In the laser irradiation method according to the thirty-second or thirty-third aspect, the first deflector includes an acousto-optic deflector or an electro-optic deflector.

### Thirty-Fifth Aspect

In the laser irradiation method according to any one of the thirty-second to thirty-fourth aspects, causing the first deflector to deflect the laser beam in the sub-scanning direction orthogonal to the main scanning direction raster-scanned by the second deflector.

### Thirty-sixth Aspect

The laser irradiation method according to any one of the thirty second to thirty-fifth aspects further includes causing the first deflector to deflect the laser beam in a first direction, causing a third deflector to deflect the laser beam, deflected by the first deflector in the first direction, in a second direction different from the first direction, and causing the second deflector to raster-scan the object with the laser beam deflected by the third deflector.

### Thirty-Seventh Aspect

In the laser irradiation method according to any one of the thirty-second to thirty-sixth aspects, a scan line interval in the raster-scanning is determined based on an irradiation density of a laser irradiation region per reference area in the object.

### Thirty-Eighth Aspect

A laser marking method includes causing a first deflector to deflect the laser beam in a first direction, causing a second deflector to raster-scan an object with the laser beam deflected by the first deflector at a scanning speed, the object having an irradiation region and a non-irradiation region separated from the irradiation region, and causing the first deflector to deflect the laser beam, which is moved to the non-irradiation region by the second deflector, to the irradiation region to irradiate the irradiation region with the laser beam when the second deflector accelerates or decelerates the scanning speed.

### Thirty-Ninth Aspect

The laser marking method according to the thirty-eighth aspect further includes deflecting the laser beam deflected by the first deflector in a first direction in a second direction different from the first direction by a third deflector between the first deflector and the second deflector.

### Fortieth Aspect

A laser irradiation device includes a first deflector to deflect a laser beam, and a second deflector to raster-scan an object, having an irradiation region and a non-irradiation region separated from the non-irradiation region, with the laser beam deflected by the first deflector. The first deflector deflects the laser beam, which is moved to the non-irradiation region by the second deflector, to the irradiation region to irradiate the irradiation region with the laser beam.

### Forty-First Aspect

In the laser irradiation device according to the fortieth aspect, the second deflector raster-scans the object with the laser beam in a main scanning direction, and the first deflector deflects the laser beam in a sub-scanning direction intersecting the main-scanning direction to irradiate the irradiation region separated from the non-irradiation region in the sub-scanning direction.

### Forty-Second Aspect

In the laser irradiation device according to the fortieth or forty-first aspect, the first deflector includes an acousto-optic deflector or an electro-optic deflector.

### Forty-Third Aspect

In the laser irradiation device according to any one of the fortieth to forty-second aspects, the first deflector deflects a laser beam in the sub-scanning direction orthogonal to the main scanning direction raster-scanned by the second deflector.

### Forty-Fourth Aspect

The laser irradiation device according to any one of the fortieth to forty-third aspects, further includes a third deflector disposed between the first deflector and the second deflector. The first deflector deflects the laser beam in a first direction, and the third deflector deflects the laser beam, which is deflected by the first deflector, in a second direction different from the first direction.

### Forty-Fifth Aspect

A laser marking device includes a first deflector to deflect a laser beam, and a second deflector to raster-scan an object having an irradiation region and a non-irradiation region separated from the irradiation region at a scanning speed. The first deflector deflects the laser beam, which is moved to the irradiation region or the non-irradiation region by the second deflector, to the irradiation region to irradiate the irradiation region with the laser beam when the second deflector accelerates or decelerates the scanning speed.

### Forty-Sixth Aspect

The laser marking device according to forty-fifth aspect further includes a third deflector disposed between the first deflector and the second deflector. The third deflector deflects a laser beam deflected by the first deflector in a first direction in a second direction different from the first direction.

### Forty-Sixth Aspect

In the laser irradiation device according to any one of the fortieth to forty-sixth aspects, a first deflection angle of a laser beam deflected by the first deflector at a predetermined coordinate of a p-th raster scanning in a raster-scanning direction is different form a second deflection angle of the laser beam deflected by the first deflector at a predetermined coordinate of a (p+q)-th raster-scanning in the raster-scanning direction, where p and q are any integers.

### Forty-Seventh Aspect

A fabricating apparatus includes the laser irradiation device according to the fortieth aspect to irradiate a powder layer with a laser beam to fabricate a fabricated layer; and a control unit to control the laser irradiation device to repeatedly fabricate the fabricated layer to fabricate a three-dimensional article.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application No. 2023-109330, filed on Jul. 3, 2023, in the Japan Patent Office, the entire disclosure of which is hereby incorporated by reference herein.

### REFERENCE SIGNS LIST

10 Laser oscillator (laser light source)
20 Acousto-optic deflector (first deflector)
21 Beam damper
30 Galvano scanner (second deflector)
40 Fθ lens (condenser lens)
50 Marking object
100, 110 Laser marking device
200 Laser irradiation device
320 Layer forming unit
321 Powder supply unit
322a Recorder
330 Preheating unit
331a, 331b, 331c First heater
332 Second heater
335 Thermometer
343 Laser window
350 Stage support

1. A laser irradiation method comprising:
causing a first deflector to deflect a laser beam;
causing a second deflector to raster-scan an object with the laser beam deflected by the first deflector, the object having an irradiation region and a non-irradiation region separated from the irradiation region; and
causing the first deflector to deflect the laser beam, which is moved to the non-irradiation region by the second deflector, to the irradiation region to irradiate the irradiation region with the laser beam.

2. The laser irradiation method according to claim 1, wherein:
the causing the second deflector to raster-scan the object with the laser beam in a main scanning direction, and
the causing the first deflector to deflect the laser beam in a sub-scanning direction intersecting the main scanning direction to irradiate the irradiation region separated from the non-irradiation region in the sub-scanning direction.

3. The laser irradiation method according to claim 1, wherein:
the first deflector includes an acousto-optic deflector or an electro-optic deflector.

4. The laser irradiation method according to claim 1, wherein:
the raster-scan by the second deflector is performed in a main scanning direction, and
the deflection by the first deflector occurs in a sub-scanning direction orthogonal to the main scanning direction.

5. The laser irradiation method according to claim 1, further comprising:
causing the first deflector to deflect the laser beam in a first direction;
causing a third deflector to deflect the laser beam, deflected by the first deflector in the first direction, in a second direction different from the first direction; and
causing the second deflector to raster-scan the object with the laser beam deflected by the third deflector.

6. The laser irradiation method according to claim 1, wherein:
a raster-scan line interval is determined based on an irradiation density of a laser irradiation region per reference area in the object.

7. A laser marking method comprising:
causing a first deflector to deflect a laser beam in a first direction;
causing a second deflector to raster-scan an object with the laser beam deflected by the first deflector at a scanning speed, the object having an irradiation region and a non-irradiation region separated from the irradiation region; and
causing the first deflector to deflect the laser beam, which is moved to the non-irradiation region by the second deflector, to the irradiation region to irradiate the irradiation region with the laser beam when the second deflector accelerates or decelerates the scanning speed.

8. The laser marking method according to claim 7, further comprising:
deflecting the laser beam deflected by the first deflector in the first direction in a second direction different from the first direction by a third deflector between the first deflector and the second deflector.

9. A laser irradiation device comprising:
a first deflector to deflect a laser beam; and
a second deflector to raster-scan an object, having an irradiation region and a non-irradiation region separated from the non-irradiation region, with the laser beam deflected by the first deflector,
wherein the first deflector deflects the laser beam, which is moved to the non-irradiation region by the second deflector, to the irradiation region to irradiate the irradiation region with the laser beam.

10. The laser irradiation device according to claim 9, wherein:
the second deflector raster-scans the object with the laser beam in a main scanning direction, and
the first deflector deflects the laser beam in a sub-scanning direction intersecting the main scanning direction to irradiate the irradiation region separated from the non-irradiation region in the sub-scanning direction.

11. The laser irradiation device according to claim 9, wherein:
the first deflector includes an acousto-optic deflector or an electro-optic deflector.

12. The laser irradiation device according to claim 9, wherein:
the first deflector deflects the laser beam in a sub-scanning direction orthogonal to a main scanning direction raster-scanned by the second deflector.

13. The laser irradiation device according to claim 9, further comprising:
a third deflector disposed between the first deflector and the second deflector,
wherein:
the first deflector deflects the laser beam in a first direction, and
the third deflector deflects the laser beam, which is deflected by the first deflector, in a second direction different from the first direction.

14. A laser marking device comprising:
a first deflector to deflect a laser beam; and
a second deflector to raster-scan an object having an irradiation region and a non-irradiation region separated from the irradiation region at a scanning speed,
wherein the first deflector deflects the laser beam, which is moved to the irradiation region or the non-irradiation region by the second deflector, to the irradiation region to irradiate the irradiation region with the laser beam when the second deflector accelerates or decelerates the scanning speed.

15. The laser marking device according to claim 14, further comprising:
a third deflector disposed between the first deflector and the second deflector, wherein the third deflector deflects a laser beam deflected by the first deflector in a first direction in a second direction different from the first direction.

16. The laser irradiation device according to claim 9, wherein:
a first deflection angle of a laser beam deflected by the first deflector at a predetermined coordinate of a p-th raster-scanning in a raster-scanning direction is different form a second deflection angle of the laser beam deflected by the first deflector at a predetermined coordinate of a (p+q)-th raster-scanning in the raster-scanning direction, where p and q are any integers.

17. A fabricating apparatus comprising:
the laser irradiation device according to claim 9 to irradiate a powder layer with a laser beam to fabricate a fabricated layer; and
control circuitry to control the laser irradiation device to repeatedly fabricate the fabricated layer to fabricate a three-dimensional article.
